(19) United States
(12) Patent Application Publication
(10) Pub. No.: US 2025/0225635 A1
(43) Pub. Date: Jul. 10, 2025

(54) FRACTURE SECTION IMAGE ANALYSIS DEVICE AND FRACTURE SECTION IMAGE ANALYSIS METHOD

(71) Applicants: KABUSHIKI KAISHA TOSHIBA, Tokyo (JP); Toshiba Tec Kabushiki Kaisha, Tokyo (JP)

(72) Inventors: Kazuhiro SUGIYAMA, Yokohama Kanagawa (JP); Miyuki UCHIDA, Yokohama Kanagawa (JP); Yusuke HIROSE, Fujisawa Kanagawa (JP); Natsumi NAKATORI, Mishima Shizuoka (JP); Jun MORIMOTO, Mishima Shizuoka (JP); Shoichi DOBASHI, Mishima Shizuoka (JP); Koichi WATANABE, Mishima Shizuoka (JP)

(21) Appl. No.: 19/000,406

(22) Filed: Dec. 23, 2024

(30) Foreign Application Priority Data
Jan. 5, 2024 (JP) 2024-000690

(51) Int. Cl. G06T 7/00; G06T 7/70

(52) U.S. Cl. CPC G06T 7/0002; G06T 7/70; G06T 2200/24; G06T 2207/20021; G06T 2207/20081

(57) ABSTRACT

According to one embodiment, a fracture section image analysis device includes an acquisitor configured to acquire a first image including a fracture section of a component, and a processor configured to perform image analysis for the first image. The image analysis includes a first process and a second process. The first process includes deriving a plurality of fracture progress directions in the fracture section. One of the plurality of fracture progress directions corresponds to one of a plurality of positions included in the fracture section. The second process includes deriving a fracture origin position in the fracture section based on at least a part of the plurality of fracture progress directions.

### CROSS-REFERENCE TO RELATED APPLICATIONS

This application is based upon and claims the benefit of priority from Japanese Patent Application No. 2024-000690, filed on Jan. 5, 2024; the entire contents of which are incorporated herein by reference.

### FIELD

Embodiments described herein relate generally to a fracture section image analysis device and a fracture section image analysis method.

### BACKGROUND

For example, analysis of a component is performed based on an image such as the fracture section of the component. Higher accuracy analysis is desired.

### BRIEF DESCRIPTION OF THE DRAWINGS

FIG. 1 is a flowchart illustrating an operation of a fracture section image analysis device according to a first embodiment;

FIG. 2 is a schematic diagram illustrating the fracture section image analysis device according to the first embodiment;

FIG. 3 is a schematic diagram illustrating a part of the operation of the fracture section image analysis device according to the first embodiment;

FIG. 4 is a schematic diagram illustrating a part of the operation of the fracture section image analysis device according to the first embodiment;

FIGS. 5A to 5F are schematic diagrams illustrating the operation of the fracture section image analysis device according to the first embodiment;

FIGS. 6A and 6B are schematic diagrams illustrating the operation of the fracture section image analysis device according to the first embodiment;

FIG. 7 is a flowchart illustrating the operation of the fracture section image analysis device according to the first embodiment;

FIG. 8 is a schematic diagram illustrating the operation of the fracture section image analysis device according to the first embodiment;

FIGS. 9A and 9B are schematic diagrams illustrating the operation of the fracture section image analysis device according to the first embodiment;

FIGS. 10A and 10B are schematic diagrams illustrating the operation of the fracture section image analysis device according to the first embodiment; and

FIG. 11 is a schematic diagram illustrating the operation of the fracture section image analysis device according to the first embodiment.

### DETAILED DESCRIPTION

According to one embodiment, a fracture section image analysis device includes an acquisitor configured to acquire a first image including a fracture section of a component, and a processor configured to perform image analysis for the first image. The image analysis includes a first process and a second process. The first process includes deriving a plurality of fracture progress directions in the fracture section. One of the plurality of fracture progress directions corresponds to one of a plurality of positions included in the fracture section. The second process includes deriving a fracture origin position in the fracture section based on at least a part of the plurality of fracture progress directions.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

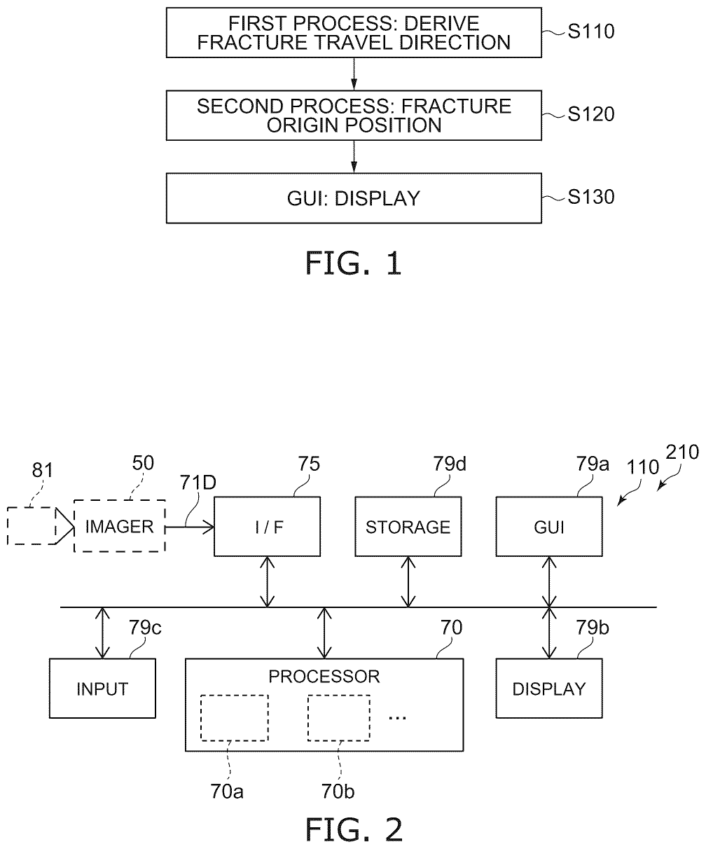

FIG. 1 is a flowchart illustrating an operation of a fracture section image analysis device according to a first embodiment.

FIG. 2 is a schematic diagram illustrating the fracture section image analysis device according to the first embodiment.

As shown in FIG. 2, a fracture section image analysis device 110 according to the embodiment includes an acquisitor 75 and a processor 70. The acquisitor 75 is configured to acquire a first image 71D. The acquisitor 75 may be, for example, an interface. The processor 70 is configured to perform image analysis on the first image 71D. The fracture section image analysis device 110 may be, for example, an image processing device.

The processor 70 may be, for example, an electric circuit (for example, circuitry). The processor 70 may be, for example, a computer. The processor 70 may include, for example, a CPU (central processing unit) and the like. The processor 70 may include, for example, a GPU (graphics processing unit) or the like.

As shown in FIG. 2, the fracture section image analysis device 110 may include a GUI 79a (Graphical User Interface). The fracture section image analysis device 110 may include a display 79b. The GUI 79a may display the desired content on the display 79b. The fracture section image analysis device 110 may include an input portion 79c, a storage 79d, and the like. The input portion 79c may include, for example, at least one of a keyboard, a mouse, a touch panel, an audio input device or the like. The storage 79d can store a part of the data used for processing or at least a part of the processing result.

The first image 71D acquired by the acquisitor 75 includes a fracture section of a component 81. The first image 71D may be obtained, for example, from an imaging device 50 that captures the fracture section of the component 81. The location where the imaging device 50 is provided may be different from the location where the fracture section image analysis device 110 is provided. The location where the imaging device 50 is provided may be the same as the location where the fracture section image analysis device 110 is provided. An analysis device 210 according to the embodiment may include the fracture section image analysis device 110 and the imaging device 50. The imaging device 50 may be considered to be included in the fracture section image analysis device 110. Information related to the first image 71D may be supplied to the acquisitor 75 by any method such as wired or wireless. For example, information related to the first image 71D may be stored in an arbitrary memory (storage 79d or the like), and the stored information may be supplied to the acquisitor 75.

The first image 71D may include, for example, a micrograph image of the fracture section of the component 81 (e.g., SEM: Scanning Electron Microscope) or the like. The component 81 may include, for example, at least one of resin or metal. The component 81 may be a component included in various devices. There is a case where the component may be destroyed. By analyzing the fractured fracture section, the cause of the fracture can be identified. Analysis of the fracture section may be performed in the development stage, design stage, manufacturing stage, or post-sales stage of various devices.

As shown in FIG. 1, the image processing performed by the processor 70 includes a first process (step S110) and a second process (step S120). The first process includes deriving (e.g., estimating) a plurality of fracture progress directions on the fracture section. One of the plurality of fracture progress directions corresponds to one of the plurality of positions included in the fracture section. As will be described later, the first image may be divided into a plurality of patch regions. The direction of fracture in each of the plurality of patch regions is derived. The plurality of patch regions can be, for example, rectangles.

The second process includes deriving a fracture origin position on the fracture section based on at least a part of the plurality of fracture progress directions. For example, by deriving fracture origin position, the mechanism of fracture can be derived with high accuracy. For example, by obtaining information on the fracture origin position, it becomes easy to obtain a policy such as a design change of the target component 81 (parts, etc.).

For example, there is a reference example for estimating the fracture mode and the like based on the image of the fracture section. The fracture mode is, for example, ductile fracture, fatigue fracture, brittle fracture, solvent crack, or grain boundary fracture. In this reference example, even if the fracture mode can be specified, the position of the origin point at which the destruction occurs is not derived. For this reason, the accuracy of the analysis is low.

On the other hand, in the embodiment, the fracture progress direction is derived. That is, the fracture progress direction (temporal change in the fracture position) in the target component 81 is estimated. Thereby, the mechanism of fracture in the target component 81 can be more accurately understood. According to the embodiment, a fracture section image analysis device capable of high-precision analysis can be provided.

In the embodiment, the fracture origin position is further derived. The fracture origin position corresponds, for example, to the origin of fracture in the target component 81. By specifying the fracture origin position, the fracture mechanism in the target component 81 can be derived with higher accuracy. Regarding the target component 81, it becomes easier to make design changes with higher accuracy. According to the embodiment, a fracture section image analysis device capable of higher accuracy analysis can be provided.

For example, as will be described later, one of the plurality of fracture progress directions can be represented by an angle θ. The angle θ is not less than 0 degrees and less than 360 degrees. One of the plurality of fracture progress directions may be represented by sin θ and cos θ. By processing information (value groups) related to a plurality of fracture progress directions, a position that serves as the origin point of a plurality of fracture progress directions can be derived. The derived position is the fracture origin position.

As shown in FIG. 1, in the embodiment, at least a part obtained by the analysis process may be displayed by the GUI (step S130).

As shown in FIG. 2, the processor 70 may include a plurality of processing portions (such as a first processing portion 70a and a second processing portion 70b). The plurality of processing portions may correspond to, for example, a plurality of models. The number of plurality of processing portions is arbitrary.

In the embodiment, the first process may include deriving one fracture progress direction at the fracture section. The second process may include deriving one fracture origin position on the fracture section based on the fracture progress direction. In the second process, for example, the fracture origin position may be derived using other information (for example, known information regarding the fracture direction and the fracture origin position).

Hereinafter, an example of the first process will be described.

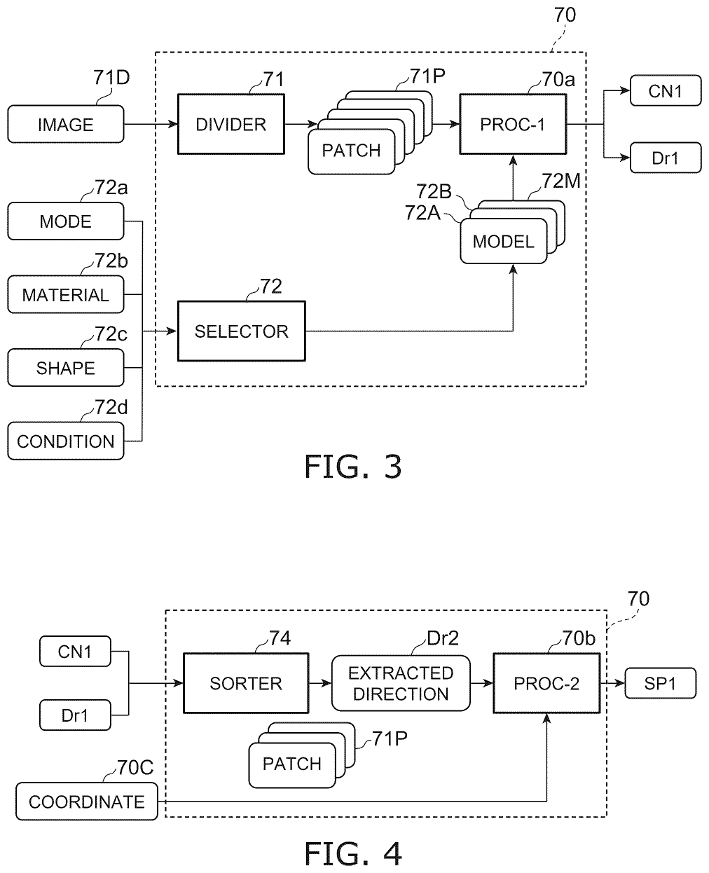

FIG. 3 is a schematic diagram illustrating a part of the operation of the fracture section image analysis device according to the first embodiment.

As shown in FIG. 3, for example, the first image 71D acquired by the acquisitor 75 is supplied to the processor 70. For example, the processor 70 includes a divider 71 and a first processing portion 70a. The divider 71 divides the first image 71D into a plurality of patch regions 71P. Information related to images included in each of the plurality of patch regions 71P obtained by dividing is supplied to the first processing portion 70a. In the first processing portion 70a, the fracture progress direction Dr1 in each of the plurality of patch regions 71P is derived.

The first processing portion 70a derives the fracture progress direction Dr1 by, for example, a processing model by deep learning. The first processing portion 70a implements, for example, performs processing based on machine learning. The processing based on machine learning is performed, for example, using one of a plurality of models 72M. The plurality of models 72M are, for example, machine-learned models.

The first processing portion 70a corresponds, for example, to a regression processor. The regression processor is configured to perform processing based on machine learning related to a plurality of teacher images including a fracture section of the component 81 and the plurality of fracture progress directions Dr1. The first process includes processing by such a regression processor (first processing portion 70a).

As shown in FIG. 3, for example, information related to the fracture mode 72a of the fracture section, information related to the material 72b of the component 81, information related to the shape 72c of the component 81, and information related to the molding condition 72d of the component 81 are supplied to the processor 70. The processor 70 includes a model selector 72. The above information is supplied to the model selector 72.

The model selector 72 selects one of the plurality of models 72M to be used in the process based on the fracture mode 72a, material 72b, shape 72c, molding condition 72d, and the like. Information about the selected model 72M is supplied to the first processing portion 70a. The first processing portion 70a derives the fracture progress direction Dr1 in each of the plurality of patch regions 71P using the selected model 72M.

Thus, the processor 70 may include the plurality of models 72M. The plurality of models 72M include the first model 72A and the second model 72B or the like. For example, in one operation (first operation), the processor 70 performs the first process using one of the plurality of models 72M (the first model 72A). In another operation (second operation), the processor 70 performs the first process using another one (second model 72B) of the plurality of models 72M. Between one of the plurality of models 72M and another one of the plurality of models 72M, the fracture mode 72a of the fracture section, the material 72b of the component 81, the shape 72c of the component 81, and the molding condition 72d of the component 81 are different.

Depending on the difference between at least one of the fracture mode 72a of the fracture section, the material 72b of the component 81, the shape 72c of the component 81, and the molding condition 72d of the component 81, one of the plurality of models 72M is selected. By using the appropriate model, more accurate processing can be performed.

The first processing portion 70a derives the fracture progress direction Dr1 for each of the plurality of patch regions 71P using one of the selected plurality of models 72M. Thus, the first process includes deriving one of the plurality of fracture progress directions Dr1 with respect to one of the plurality of patch regions 71P obtained by dividing the first image 71D acquired by the acquisitor 75.

The processor 70 outputs at least a part of the plurality of fracture progress directions Dr1 being derived.

The processor 70 may output a certainty factor CN1 for each of the plurality of fracture progress direction Dr1. Thus, the first process may further include deriving the certainty factor CN1 for each of the plurality of fracture progress directions Dr1 being derived. As will be described later, the processor 70 may perform the second process according to the certainty factor CN1. From 2 or more of the plurality of fracture progress directions Dr1, the certainty factor CN1 may be derived for one of the plurality of fracture progress directions Dr1.

Hereinafter, an example of the second process will be described.

FIG. 4 is a schematic diagram illustrating a part of the operation of the fracture section image analysis device according to the first embodiment.

FIG. 4 shows an example of the second process. As shown in FIG. 4, the processor 70 may include a patch extractor 74 and the second processing portion 70b. For example, the plurality of fracture progress directions Dr1 and certainty factor CN1 are supplied to the patch extractor 74. The patch extractor 74 extracts at least a part of the plurality of patch regions 71P used to derive a fracture origin position SP1 based on the certainty factor CN1. Alternatively, the patch extractor 74 extracts at least a part of the plurality of patch regions 71P that are not used to derive the fracture origin position SP1 based on the certainty factor CN1. By the operation of the patch extractor 74, a part of the plurality of fracture progress directions Dr1 (post-extraction fracture direction Dr2) used for deriving the fracture origin position SP1 is extracted.

For example, there is the plurality of fracture progress direction Dr1 (post-extraction fracture progress direction Dr2) having the certainty factor CN1 higher than a determined reference value. The second processing portion 70b derives the fracture origin position SP1 using the post-extraction fracture progress direction Dr2.

On the other hand, for example, the certainty factor CN1 of at least one of the plurality of fracture progress directions Dr1 is less than the determined reference value. The second processing portion 70b derives the fracture origin position SP1 without using at least one of such the plurality of fracture progress directions Dr1. The certainty factor CN1 corresponding to at least one of the plurality of fracture direction Dr1 that is not used is less than the determined reference value.

By not using data with the certainty factor CN1 being low, the fracture origin position SP1 can be derived with higher accuracy.

In deriving the fracture origin position SP1, a determined coordinate (reference coordinate 70C) may be used. As already described, for example, the first image 71D is obtained from the imaging device 50 that captures the fracture section of the component 81 (see FIG. 2). The reference coordinate 70C is a reference coordinate at the time of imaging of the imaging device 50, for example. The reference coordinate 70C at the time of imaging of the imaging device 50 may be, for example, a coordinate set on a stage where the imaging device 50 is provided. The second process may include deriving the fracture origin position SP1 using common coordinates (reference coordinates 70C) for the plurality of fracture progress directions Dr1. By processing the plurality of fracture progress directions Dr1 using common coordinates (reference coordinates 70C), the fracture origin position SP1 can be derived with high accuracy.

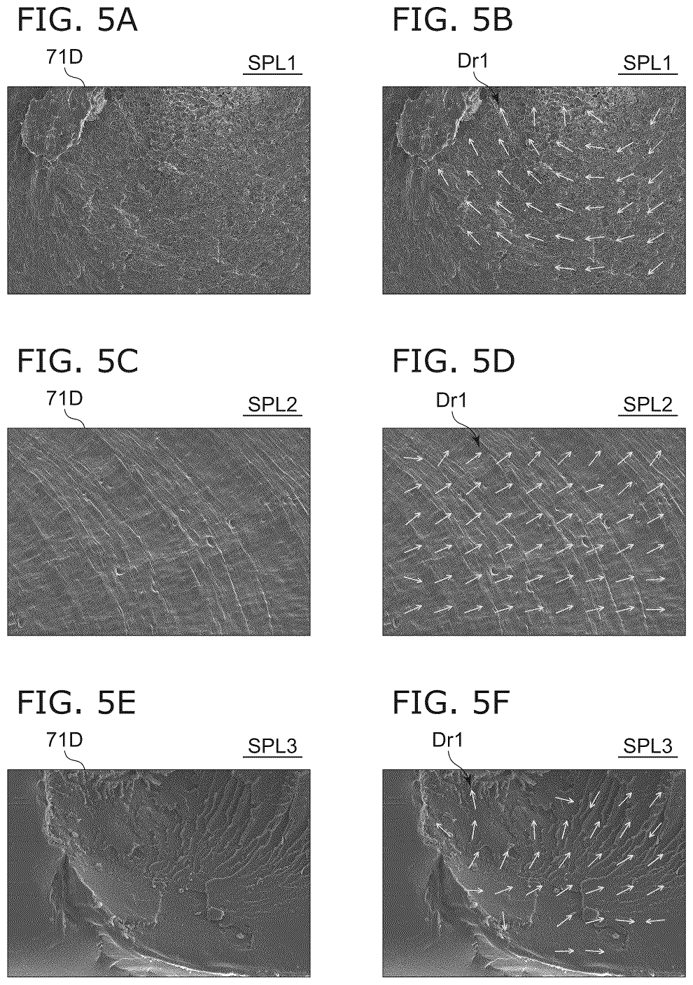

FIGS. 5A to 5F are schematic diagrams illustrating the operation of the fracture section image analysis device according to the first embodiment.

FIGS. 5A and 5B relate to a first sample SPL1. FIGS. 5C and 5D relate to a second sample SPL2. FIGS. 5E and 5F relate to a third sample SPL3. FIGS. 5A, 5C, and 5E correspond to the first image 71D of these samples (fracture sections). FIG. 5B shows the plurality of fracture progress directions Dr1 derived from the first image 71D of FIG. 5A. FIG. 5D shows the plurality of fracture progress directions Dr1 derived from the first image 71D of FIG. 5C. FIG. 5F shows the plurality of fracture progress directions Dr1 derived from the first image 71D of FIG. 5E.

For example, the first image 71D is divided into the plurality of patch regions 71P (see FIG. 3). In each of the divided plurality of patch regions 71P, one of the plurality of fracture progress direction Dr1 is derived by the first processing portion 70a based on the machine learning model.

In this example, the first sample SPL1 corresponds to ductile fracture. The second sample SPL2 corresponds to fatigue fracture. The third sample SPL3 corresponds to brittle fracture. These different types of fracture modes correspond to the fracture mode 72a (see FIG. 3). Depending on the difference in the fracture mode, one of the plurality of models 72M is selected to derive the plurality of fracture progress directions Dr1.

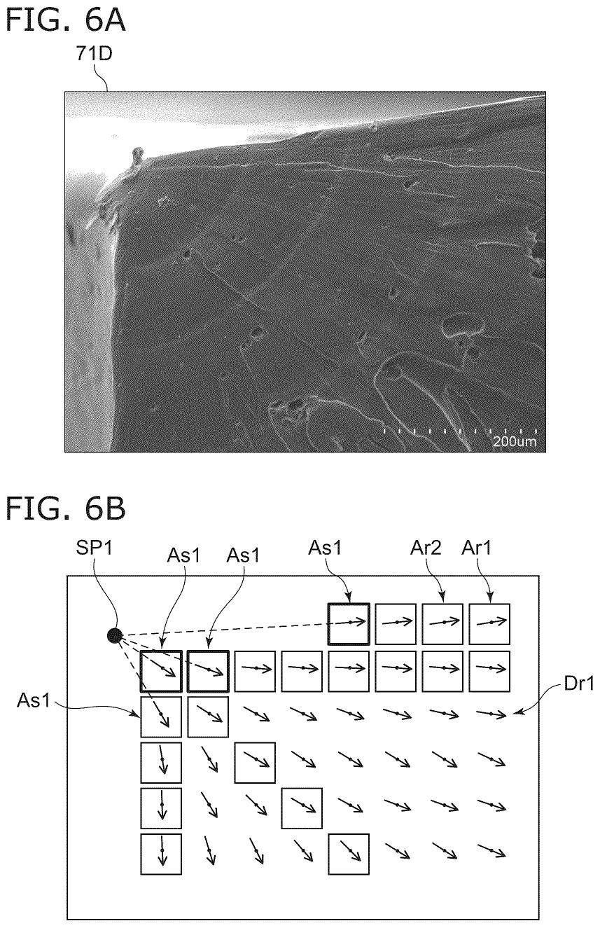

FIGS. 6A and 6B are schematic diagrams illustrating the operation of the fracture section image analysis device according to the first embodiment.

FIG. 6A illustrates the first image 71D. FIG. 6B illustrates the plurality of fracture progress directions Dr1 derived from the first image 71D of FIG. 6A and the fracture origin position SP1 derived from the plurality of fracture progress directions Dr1.

As shown in FIG. 6B, the plurality of fracture progress directions Dr1 are derived with respect to the first image 71D. In this example, the plurality of fracture progress directions Dr1 are displayed by arrows Ar1. For example, if one arrow Ar1 is selected and there is “another arrow Ar2” on the origin side of the arrow Ar1, the “another arrow Ar2” is considered to be a new arrow. With respect to the new arrow, if there is “yet another arrow” on the origin side of the new arrow, the “yet another arrow” is considered to be a new arrow. By repeating such an operation, the origin arrow As1 is determined with respect to the first selected arrow Ar1. Such an operation is performed with respect to the plurality of fracture progress direction Dr1 (plurality of arrows) arranged in two dimensions. By repeated operations, the plurality of origin arrows As1 are derived. The crossing point of each extension line of the plurality of arrows As1 can be estimated to be the fracture origin position SP1.

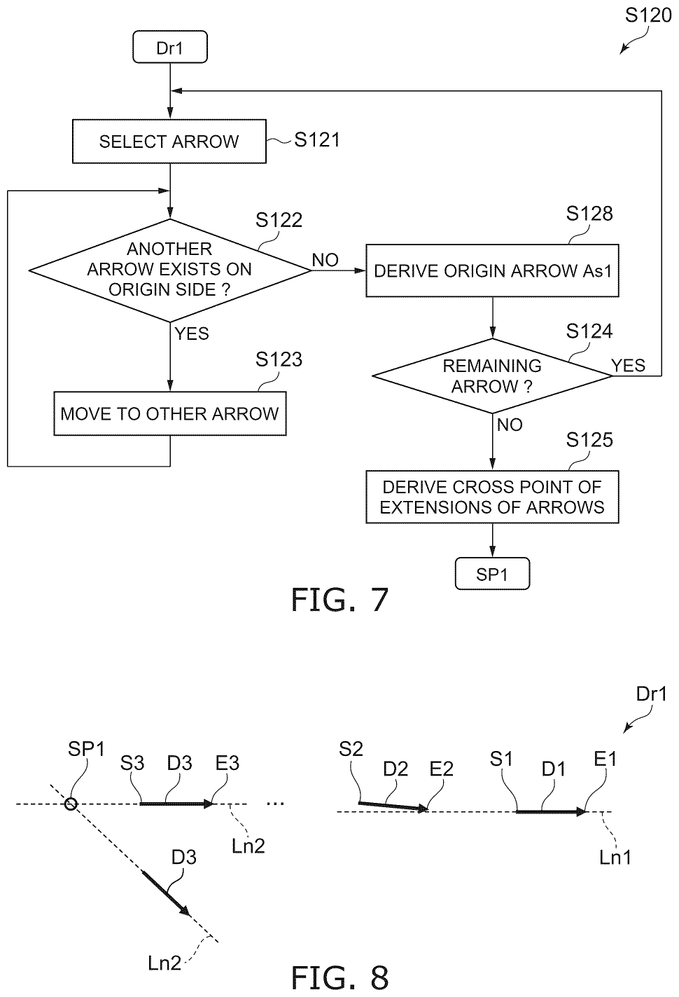

FIG. 7 is a flowchart illustrating the operation of the fracture section image analysis device according to the first embodiment.

FIG. 7 illustrates the second process (step S120). In this example, the plurality of fracture progress direction Dr1 are represented as the plurality of arrows. For example, one of the plurality of arrows (for example, arrow Ar1) is selected as one of the plurality of fracture progress directions Dr1 (step S121). It is determined whether there is another arrow (for example, arrow Ar2) on the origin side of the selected arrow Ar1 (step S122). If there is another arrow (for example, arrow Ar2), move to another arrow Ar2 (step S123). In step S122, when there is no other arrow Ar2, the process proceeds to step S124.

In step S124, it is determined whether there are remaining arrows. If there are remaining arrows, the process is returned to step S121 and arrow selection is performed. By steps S121 and S122, the origin arrow As1 is derived for one of the initially selected plurality of arrows (e.g., arrow Ar1) (step S128).

By repeating the process including steps S121, step S122, step S123 and step S124, the plurality of origin arrows As1 are derived with respect to the plurality of two-dimensional fracture progress directions Dr1.

In step S124, if there are no remaining arrows, the process proceeds to step S125. In step S125, the cross point of the extensions of the arrows As1 of the plurality of origins is calculated. The cross point is output, for example, as the fracture origin position SP1.

FIG. 8 is a schematic diagram illustrating the operation of the fracture section image analysis device according to the first embodiment.

FIG. 8 shows one example of a method for deriving the fracture origin position SP1 based on the plurality of fracture progress directions Dr1. As shown in FIG. 8, the plurality of fracture progress directions Dr1 includes a first direction D1, a second direction D2, and a third direction D3. The first direction D1 is a direction from a first origin S1 to a first end point E1. The second direction D2 is a direction from a second origin S2 to a second end point E2. The third direction D3 is a direction from a third origin S3 to a third end point E3.

A position of the second end point E2 in the straight line Ln1 along the first direction D1 is between a position of the second origin S2 in the straight line Ln1 and a position of the first end point E1 in the straight line Ln1. A position of the first origin S1 in the straight line Ln1 is between the position of the second end point E2 in the straight line Ln1 and the position of the first end point E1 in the straight line Ln1.

The first direction D1 corresponds, for example, to the arrow Ar1. The second direction D2 corresponds to another arrow Ar2. Based on the first direction D1, the second direction D2 can be derived. The second direction D2 (another arrow Ar2) is closest to the first direction D1, for example, among other directions (another arrow). The angle between the second direction D2 and the straight line Ln1 is smaller than the angle between the other direction (another arrow) and the straight line Ln1. With respect to the first direction D1, such a second direction D2 can be determined.

For example, the second process includes repeating the origin derivation process. One of the origin derivation processes includes identifying the second direction D2 based on the first direction D1. The third direction D3 corresponds to the second direction D2 specified by repeating the origin point derivation process. In the second process, the position on an extension line Ln2 of the orientation from the third end point E3 to the third origin S3 of the third direction D3 obtained by repeating the origin point derivation process is a candidate for the fracture origin position SP1. By repeating the origin derivation process, the plurality of extension lines Ln2 are obtained. The crossing point of the plurality of extension lines Ln2 becomes the fracture origin position SP1.

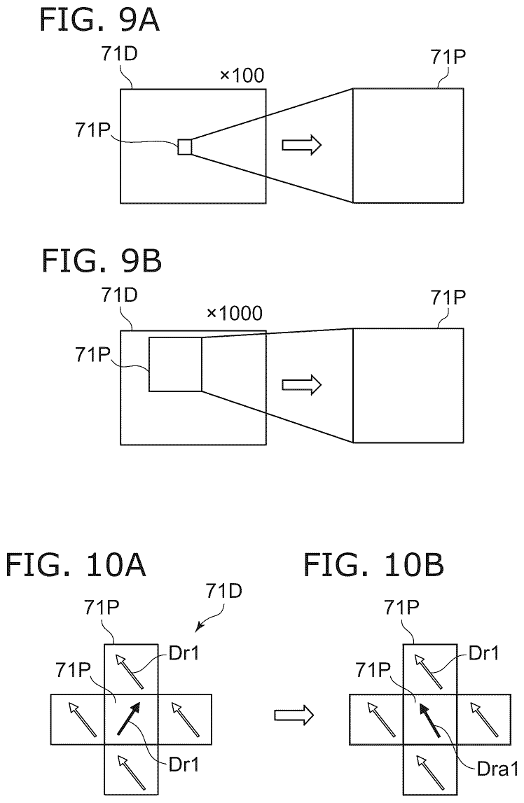

FIGS. 9A and 9B are schematic diagrams illustrating the operation of the fracture section image analysis device according to the first embodiment.

In FIGS. 9A and 9B, the magnifications of the first image 71D differ from each other. The magnification of the imaging of the first image 71D in FIG. 9A is lower than the magnification of the imaging of the first image 71D in FIG. 9B. The magnification rate of the plurality of patch regions 71P in FIG. 9A is higher than the magnification rate of the plurality of patch regions 71P in FIG. 9B. Thus, the first process may include changing the range included in at least one of the plurality of patch regions 71P according to the magnification of the imaging of the first image 71D. For example, the first image 71D being input is adjusted to a size suitable for the processing model by deep learning. Appropriate processing can be performed with high accuracy.

FIGS. 10A and 10B are schematic diagrams illustrating the operation of the fracture section image analysis device according to the first embodiment.

As shown in FIG. 10A, for example, the plurality of fracture progress directions Dr1 are derived for the plurality of patch regions 71P. At this time, one of the plurality of fracture progress directions Dr1 may differ significantly (beyond the threshold value) from other of the plurality of fracture progress direction Dr1. The other of the plurality of fracture progress directions Dr1 is next to the plurality of fracture progress directions Dr1.

In such a case, as shown in FIG. 10B, one of the significantly different multiple fracture progress direction Dr1 (averaged fracture progress direction Dra1) may be modified based on the other average direction. The averaged fracture progress direction Dra1 is obtained, for example, by averaging at least a part of the plurality of fracture progress direction Dr1. The averaging may be, for example, averaging in units of the plurality of patch regions 71P. By using the averaged fracture progress direction Dra1, for example, the fracture origin position SP1 can be derived with higher accuracy.

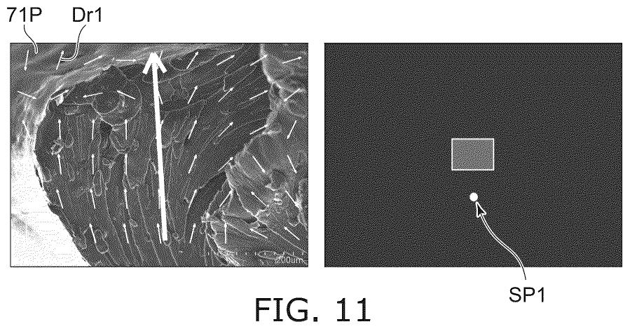

FIG. 11 is a schematic diagram illustrating the operation of the fracture section image analysis device according to the first embodiment.

FIG. 11 shows an example of a display by GUI 79a in the fracture section image analysis device 110. For example, the derived plurality of fracture progress directions Dr1 may be superimposed and displayed on the input image (first image 71D). For example, depending on the certainty factor CN1, at least a part of the plurality of fracture progress directions Dr1 may be filtered. For example, depending on the specified resolution, the plurality of fracture progress directions Dr1 may be displayed. For example, the fracture origin position SP1 is displayed. The fracture origin position SP1 may be superimposed and displayed on the input image (first image 71D). For example, the plurality of images and the fracture origin position SP1 may be displayed based on the image coordinate system for display.

Thus, the fracture section image analysis device 110 may further include a GUI 79a. The GUI 79a is configured to perform at least one of the following operations: a first display operation, a second display operation, a third display operation, a fourth display operation, a fifth display operation, a sixth display operation, or a seventh display operation.

In the first display operation, the GUI 79a displays, for example, at least a part of the plurality of fracture progress directions Dr1 superimposed on the first image 71D. In the second display operation, the GUI 79a selectively displays, for example, a part of the plurality of fracture progress directions Dr1 according to the orientation of the plurality of fracture progress directions Dr1.

In the third display operation, the GUI 79a displays, for example, a part of the plurality of fracture progress directions Dr1 in units of the plurality of patch regions 71P. In the fourth display operation, the GUI 79a displays the plurality of fracture progress directions Dr1 for the entire first image 71D.

In the fifth display operation, the GUI 79a displays, for example, the averaging fracture progress direction Dra1. The averaged fracture progress direction Dra1 is obtained by averaging at least a part of the plurality of fracture progress direction Dr1. The method of averaging is arbitrary. At least one of the plurality of fracture progress directions Dr1 before averaging may be displayed.

In the sixth display operation, the GUI 79a displays the plurality of patch regions 71P in an image coordinate system. In the seventh display operation, the GUI 79a displays the fracture origin position SP1.

The GUI 79a may be configured to perform at least one of an eighth display operation and a ninth display operation. In the eighth display operation, the GUI 79a selectively displays a part of the plurality of fracture progress directions Dr1 based on, for example, the certainty factor CN1 for each of the plurality of fracture progress directions Dr1. In the ninth display operation, the GUI 79a selectively displays a part of the plurality of fracture progress directions Dr1 (for example, arrow As1) used in deriving the fracture origin position SP1, for example.

In addition to the above, the GUI 79a may display arbitrary contents. The contents include, for example, conditions related to image processing. The contents may include, for example, commands related to image processing.

### Second Embodiment

The second embodiment relates to a fracture section image analysis method. The fracture section image analysis method acquires the first image 71D including the fracture section of the component 81. The fracture section image analysis method performs image analysis on the first image 71D. For example, in the fracture section image analysis method, image analysis for the first image 71D is performed by the processor 70. For example, image analysis includes the first process and the second process. The first process includes deriving the plurality of fracture progress directions Dr1 on the fracture section. One of the plurality of fracture progress directions Dr1 corresponds to one of a plurality of locations (e.g., the plurality of patch regions 71P) included in the fracture section. The second process includes deriving the fracture origin position SP1 on the fracture section based on at least a part of the plurality of fracture progress directions Dr1.

In the fracture section image analysis method according to the embodiment, at least a part of the operation of the fracture section image analysis device 110 described with respect to the first embodiment may be applied.

According to the embodiments, at least a part of the fracture section image analysis is automated. The analysis of the fracture sections can be performed at high speed and with high accuracy. In the embodiments, the plurality of fracture progress directions Dr1 are derived based on the image regarding the fracture section. Furthermore, the fracture origin position SP1 can be derived from the plurality of fracture progress directions Dr1. As a result, it is possible to perform analysis that is difficult to perform with image analysis of reference examples by image classification. In one example according to the embodiment, the model suitable for each of the different fracture modes is employed. Higher accuracy analysis is possible. In the embodiment, even when the first image 71D includes a lot of noise, it is easy to obtain appropriate analysis results. The fracture section image analysis method according to the embodiment may be, for example, a fracture section image processing method. The fracture section image analysis method according to the embodiment may be, for example, a fracture section analysis method.

The Embodiments may include the following Technical proposals.

### (Technical Proposal 1)

A fracture section image analysis device, comprising:
an acquisitor configured to acquire a first image including a fracture section of a component; and
a processor configured to perform image analysis for the first image;
the image analysis including a first process and a second process,
the first process including deriving a plurality of fracture progress directions in the fracture section,
one of the plurality of fracture progress directions corresponding to one of a plurality of positions included in the fracture section,
the second process including deriving a fracture origin position in the fracture section based on at least a part of the plurality of fracture progress directions.

### (Technical Proposal 2)

The fracture section image analysis device according to Technical proposal 1, wherein
the processor includes a plurality of models,
in the first operation, the processor performs the first process using one of the plurality of models,
in the second operation, the processor performs the first process using another one of the plurality of models,
at least one of a fracture mode of the fracture section, a material of the component, a shape of the component, or a molding conditions of the component are different between the one of the plurality of models and the other one of the plurality models.

### (Technical Proposal 3)

The fracture section image analysis device according to Technical proposal 1 or 2, wherein
the first process includes deriving one of the plurality of fracture progress directions with respect to one of a plurality of patch regions obtained by dividing the first image acquired by the acquisitor.

### (Technical Proposal 4)

The fracture section image analysis device according to Technical proposal 3, wherein
the first process includes changing a range included in at least one of the plurality of patch regions according to a magnification of imaging of the first image.

### (Technical Proposal 5)

The fracture section image analysis device according to any one of Technical proposals 1-4, wherein
the first process further includes deriving a certainty factor regarding each of the plurality of fracture progress directions being derived,
the second process includes deriving the fracture origin position without using at least one of the plurality of fracture progress directions, and the certainty factor corresponding to the at least one of the plurality of fracture progress directions is less than a determined reference value.

### (Technical Proposal 6)

The fracture section image analysis device according to any one of Technical proposals 1-5, wherein
the first image is obtained from an imaging device configured to capture the fractured section,
the second process includes deriving the fracture origin position using a coordinate being common for the plurality of fracture progress directions, and
the coordinate is a reference coordinate at a time of imaging of the imaging device.

### (Technical Proposal 7)

The fracture section image analysis device according to Technical proposal 3 or 4, further comprising:
a GUI,
the GUI being configured to perform at least one of a first display operation, a second display operation, a third display operation, a fourth display operation, a fifth display operation, a sixth display operation, or a seventh display operation,
in the first display operation, the GUI being configured to display at least a part of the plurality of fracture progress directions superimposed on the first image,
in the second display operation, the GUI being configured to selectively display a part of the plurality of fracture progress directions according to an orientation of the plurality of fracture progress directions,
in the third display operation, the GUI being configured to display a part of the plurality of fracture progress directions in unit of the plurality of patch regions,
in the fourth display operation, the GUI being configured to display the plurality of fracture progress directions for entire first image,
in the fifth display operation, the GUI being configured to display an averaged fracture progress direction of progress, and the averaged fracture progress direction is obtained by averaging at least a part of the plurality of fracture progress directions,
in the sixth display operation, the GUI being configured to display the plurality of patch regions in an image coordinate system, and
in the seventh display operation, the GUI being configured to display the fracture origin position.

### (Technical Proposal 8)

The fracture section image analysis device according to any one of Technical proposals 1-4, further comprising:
a GUI,
the GUI being configured to perform at least one of the eighth display operation or the ninth display operation,
in the eighth display operation, the GUI being configured to selectively display a part of the plurality of fracture progress directions based on a certainty factor regarding each of the plurality of fracture progress directions, and
in the ninth display operation, the GUI being configured to selectively display the part of the plurality of fracture progress directions used in deriving the fracture origin position.

### (Technical Proposal 9)

The fracture section image analysis device according to any one of Technical proposals 1-8, wherein
the plurality of fracture progress directions include a first direction, a second direction, and a third direction,
the first direction is a direction from a first origin to a first end point,
the second direction is a direction from a second origin to a second end point,
the third direction is a direction from a third origin to a third end point,
a position of the second end point in a straight line along the first direction is between a position of the second origin in the straight line and a position of the first end point in the straight line,
a position of the first origin in the straight line is between the position of the second end point in the straight line and the position of the first end point in the straight line,
the second process includes repeating an origin point derivation process,
one of the origin derivation processes includes determining the second direction based on the first direction,
a third direction corresponds to the second direction specified by the repeating the origin derivation process,
the second process causing a position on an extension line of an orientation from the third end point to the third origin obtained by repeating the origin point derivation process to be a candidate for the fracture origin position.

### (Technical Proposal 10)

The fracture section image analysis device according to any one of Technical proposals 1-9, wherein
the first process includes a process by a regression processor configured to perform processing based on machine learning related to a plurality of teacher images including the fracture section and the plurality of fracture progress directions.

### (Technical Proposal 11)

A fracture section image analysis method, comprising:
acquiring a first image including a fracture section of a component; and
performing image analysis on the first image by a processor,
the image analysis including a first process and a second process,
the first process including deriving a plurality of fracture progress directions in the fracture section,
one of the plurality of fracture progress directions corresponding to one of a plurality of positions included in the fracture section,
the second process including deriving a fracture origin position in the fracture section based on at least a part of the plurality of fracture progress directions.

### (Technical Proposal 12)

The fracture section image analysis method according to Technical proposal 11, wherein
the processor includes a plurality of models,
in the first operation, the processor performs the first process using one of the plurality of models,
in the second operation, the processor performs the first process using another one of the plurality of models,
at least one of a fracture section fracture mode, a material of the component, a shape of the component, or a molding conditions of the component is different between the one of the plurality of models and the other one of the plurality models.

### (Technical Proposal 13)

The fracture section image analysis method according to Technical proposal 11 or 12, wherein
the first process includes deriving one of the plurality of fracture progress directions with respect to one of a plurality of patch regions obtained by dividing the first image.

### (Technical Proposal 14)

The fracture section image analysis method according to Technical proposal 13, wherein
the first process includes changing a range included in at least one of the plurality of patch regions according to a magnification of the imaging of the first image.

### (Technical Proposal 15)

The fracture section image analysis method according to any one of Technical proposals 11-14, wherein
the first process further includes deriving a certainty factor regarding each of the plurality of fracture progress directions being derived,
the second process includes deriving the fracture origin position without using at least one of the plurality of fracture progress directions, and the certainty factor corresponding to the at least one of the plurality of fracture progress direction is less than a determined reference value.

### (Technical Proposal 16)

The fracture section image analysis method according to any one of Technical proposal 11-15, wherein
the first image is obtained from an imaging device configured to capture the fractured section,
the second process includes deriving the fracture origin position using a coordinates being common for the plurality of fracture progress directions, and
the coordinate is a reference coordinates at time of imaging of the imaging device.

### (Technical Proposal 17)

The fracture section image analysis method according to Technical proposal of 13 or 14, further comprising:
performing at least one of a first display operation, a second display operation, a third display operation, a fourth display operation, a fifth display operation, a sixth display operation, or a seventh display operation,
in the first display operation, at least a part of the plurality of fracture progress directions being superimposed on the first image,
in the second display operation, a part of the plurality of fracture progress directions being selectively displayed according to the direction of the plurality of fracture progress directions,
in the third display operation, a part of the plurality of fracture progress directions being displayed in unit of the plurality of patch regions,
in the fourth display operation, the plurality of fracture progress directions for the entire first image being displayed,
in the fifth display operation, the averaged fracture progress direction being displayed, and the averaged fracture progress direction being obtained by averaging at least a part of the plurality of fracture progress directions,
in the sixth display operation, the plurality of patch regions being displayed in an image coordinate system,
in the seventh display operation, the fracture origin point being displayed position is displayed.

### (Technical Proposal 18)

The fracture section image analysis method according to any one of the Technical proposal 11-14, further comprising:
performing at least one of an eighth display operation or a ninth display operation,
in the eighth display operation, a part of the plurality of fracture progress directions being selectively displayed based on a certainty factor regarding each of the plurality of fracture progress directions,
in the ninth display operation, the part of the plurality of fracture progress directions used in deriving the fracture origin position.

### (Technical Proposal 19)

The fracture section image analysis method according to any one of the Technical proposal 11-18, wherein
the plurality of fracture progress directions include a first direction, a second direction, and a third direction,
the first direction is a direction from a first origin to a first end point,
the second direction is a direction from a second origin to a second end point,
the third direction is a direction from a third origin to a third end point,
a position of the second end point in a straight line along the first direction is between a position of the second origin in the straight line and a position of the first end point in the straight line,
a position of the first origin in the straight line is between the position of the second end point in the straight line and the position of the first end point in the straight line,
the second process includes repeating an origin point derivation process,
one of the origin derivation processes includes determining the second direction based on the first direction,
a third direction corresponds to the second direction specified by the repeating the origin derivation process,
the second process causing a position on an extension line of an orientation from the third end point to the third origin obtained by repeating the origin point derivation process to be a candidate for the fracture origin position.

### (Technical Proposal 20)

The fracture section image analysis method according to any one of the Technical proposal 11-19, wherein
the first process includes a process by a regression processor configured to perform processing based on machine learning related to a plurality of teacher images including the fracture section and the plurality of fracture progress directions.

According to the embodiment, it is possible to provide a fracture section image analysis device and a fracture section image analysis method that are capable of highly accurate analysis.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in fracture section image analysis devices such as acquisitors, processors, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all fracture section image analysis devices and all fracture section image analysis methods practicable by an appropriate design modification by one skilled in the art based on the fracture section image analysis devices and the fracture section image analysis methods described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A fracture section image analysis device, comprising:
an acquisitor configured to acquire a first image including a fracture section of a component; and
a processor configured to perform image analysis for the first image;
the image analysis including a first process and a second process,
the first process including deriving a plurality of fracture progress directions in the fracture section,
one of the plurality of fracture progress directions corresponding to one of a plurality of positions included in the fracture section,
the second process including deriving a fracture origin position in the fracture section based on at least a part of the plurality of fracture progress directions.

2. The fracture section image analysis device according to claim 1, wherein
the processor includes a plurality of models,
in the first operation, the processor performs the first process using one of the plurality of models,
in the second operation, the processor performs the first process using another one of the plurality of models,
at least one of a fracture mode of the fracture section, a material of the component, a shape of the component, or a molding conditions of the component are different between the one of the plurality of models and the other one of the plurality models.

3. The fracture section image analysis device according to claim 1, wherein
the first process includes deriving one of the plurality of fracture progress directions with respect to one of a plurality of patch regions obtained by dividing the first image acquired by the acquisitor.

4. The fracture section image analysis device according to claim 3, wherein
the first process includes changing a range included in at least one of the plurality of patch regions according to a magnification of imaging of the first image.

5. The fracture section image analysis device according to claim 1, wherein
the first process further includes deriving a certainty factor regarding each of the plurality of fracture progress directions being derived,
the second process includes deriving the fracture origin position without using at least one of the plurality of fracture progress directions, and the certainty factor corresponding to the at least one of the plurality of fracture progress directions is less than a determined reference value.

6. The fracture section image analysis device according to claim 1, wherein
the first image is obtained from an imaging device configured to capture the fractured section,
the second process includes deriving the fracture origin position using a coordinate being common for the plurality of fracture progress directions, and
the coordinate is a reference coordinate at a time of imaging of the imaging device.

7. The fracture section image analysis device according to claim 3, further comprising:
a GUI,
the GUI being configured to perform at least one of a first display operation, a second display operation, a third display operation, a fourth display operation, a fifth display operation, a sixth display operation, or a seventh display operation,
in the first display operation, the GUI being configured to display at least a part of the plurality of fracture progress directions superimposed on the first image,
in the second display operation, the GUI being configured to selectively display a part of the plurality of fracture progress directions according to an orientation of the plurality of fracture progress directions,
in the third display operation, the GUI being configured to display a part of the plurality of fracture progress directions in unit of the plurality of patch regions,
in the fourth display operation, the GUI being configured to display the plurality of fracture progress directions for entire first image,
in the fifth display operation, the GUI being configured to display an averaged fracture progress direction of progress, and the averaged fracture progress direction is obtained by averaging at least a part of the plurality of fracture progress directions,
in the sixth display operation, the GUI being configured to display the plurality of patch regions in an image coordinate system, and
in the seventh display operation, the GUI being configured to display the fracture origin position.

8. The fracture section image analysis device according to claim 1, further comprising:
a GUI,
the GUI being configured to perform at least one of the eighth display operation or the ninth display operation,
in the eighth display operation, the GUI being configured to selectively display a part of the plurality of fracture progress directions based on a certainty factor regarding each of the plurality of fracture progress directions, and
in the ninth display operation, the GUI being configured to selectively display the part of the plurality of fracture progress directions used in deriving the fracture origin position.

9. The fracture section image analysis device according to claim 1, wherein
the plurality of fracture progress directions include a first direction, a second direction, and a third direction,
the first direction is a direction from a first origin to a first end point,
the second direction is a direction from a second origin to a second end point,
the third direction is a direction from a third origin to a third end point,
a position of the second end point in a straight line along the first direction is between a position of the second origin in the straight line and a position of the first end point in the straight line,
a position of the first origin in the straight line is between the position of the second end point in the straight line and the position of the first end point in the straight line,
the second process includes repeating an origin point derivation process,
one of the origin derivation processes includes determining the second direction based on the first direction,
a third direction corresponds to the second direction specified by the repeating the origin derivation process,
the second process causing a position on an extension line of an orientation from the third end point to the third origin obtained by repeating the origin point derivation process to be a candidate for the fracture origin position.

10. The fracture section image analysis device according to claim 1, wherein
the first process includes a process by a regression processor configured to perform processing based on machine learning related to a plurality of teacher images including the fracture section and the plurality of fracture progress directions.

11. A fracture section image analysis method, comprising:
acquiring a first image including a fracture section of a component; and
performing image analysis on the first image by a processor,
the image analysis including a first process and a second process,
the first process including deriving a plurality of fracture progress directions in the fracture section,
one of the plurality of fracture progress directions corresponding to one of a plurality of positions included in the fracture section,
the second process including deriving a fracture origin position in the fracture section based on at least a part of the plurality of fracture progress directions.

12. The fracture section image analysis method according to claim 11, wherein
the processor includes a plurality of models,
in the first operation, the processor performs the first process using one of the plurality of models,
in the second operation, the processor performs the first process using another one of the plurality of models,
at least one of a fracture section fracture mode, a material of the component, a shape of the component, or a molding conditions of the component is different between the one of the plurality of models and the other one of the plurality models.

13. The fracture section image analysis method according to claim 11, wherein
the first process includes deriving one of the plurality of fracture progress directions with respect to one of a plurality of patch regions obtained by dividing the first image.

14. The fracture section image analysis method according to claim 13, wherein
the first process includes changing a range included in at least one of the plurality of patch regions according to a magnification of the imaging of the first image.

15. The fracture section image analysis method according to claim 11, wherein
the first process further includes deriving a certainty factor regarding each of the plurality of fracture progress directions being derived,
the second process includes deriving the fracture origin position without using at least one of the plurality of fracture progress directions, and the certainty factor corresponding to the at least one of the plurality of fracture progress direction is less than a determined reference value.

16. The fracture section image analysis method according to claim 11, wherein
the first image is obtained from an imaging device configured to capture the fractured section,
the second process includes deriving the fracture origin position using a coordinates being common for the plurality of fracture progress directions, and
the coordinate is a reference coordinates at time of imaging of the imaging device.

17. The fracture section image analysis method according to claim 13, further comprising:
performing at least one of a first display operation, a second display operation, a third display operation, a fourth display operation, a fifth display operation, a sixth display operation, or a seventh display operation,
in the first display operation, at least a part of the plurality of fracture progress directions being superimposed on the first image,
in the second display operation, a part of the plurality of fracture progress directions being selectively displayed according to the direction of the plurality of fracture progress directions,
in the third display operation, a part of the plurality of fracture progress directions being displayed in unit of the plurality of patch regions,
in the fourth display operation, the plurality of fracture progress directions for the entire first image being displayed,
in the fifth display operation, the averaged fracture progress direction being displayed, and the averaged fracture progress direction being obtained by averaging at least a part of the plurality of fracture progress directions,
in the sixth display operation, the plurality of patch regions being displayed in an image coordinate system,
in the seventh display operation, the fracture origin point being displayed position is displayed.

18. The fracture section image analysis method according to claim 11, further comprising:
performing at least one of an eighth display operation or a ninth display operation,
in the eighth display operation, a part of the plurality of fracture progress directions being selectively displayed based on a certainty factor regarding each of the plurality of fracture progress directions,
in the ninth display operation, the part of the plurality of fracture progress directions used in deriving the fracture origin position.

19. The fracture section image analysis method according to claim 11, wherein
the plurality of fracture progress directions include a first direction, a second direction, and a third direction,
the first direction is a direction from a first origin to a first end point,
the second direction is a direction from a second origin to a second end point,
the third direction is a direction from a third origin to a third end point,
a position of the second end point in a straight line along the first direction is between a position of the second origin in the straight line and a position of the first end point in the straight line,
a position of the first origin in the straight line is between the position of the second end point in the straight line and the position of the first end point in the straight line,
the second process includes repeating an origin point derivation process,
one of the origin derivation processes includes determining the second direction based on the first direction,
a third direction corresponds to the second direction specified by the repeating the origin derivation process,
the second process causing a position on an extension line of an orientation from the third end point to the third origin obtained by repeating the origin point derivation process to be a candidate for the fracture origin position.

20. The fracture section image analysis method according to claim 11, wherein
the first process includes a process by a regression processor configured to perform processing based on machine learning related to a plurality of teacher images including the fracture section and the plurality of fracture progress directions.
